(19) United States
(12) Patent Application Publication
(10) Pub. No.: US 2026/0275095 A1
(43) Pub. Date: Sep. 17, 2026

(54) BUTENE (CO)POLYMER-BASED SEALING MATERIAL FOR CONTAINER CLOSURES

(71) Applicant: ACTEGA GMBH, Wesel (DE)

(72) Inventors: Dany Mängel, Twistringen (DE); Mattias Kern, Lilienthal (DE)

(21) Appl. No.: 19/164,057

(22) PCT Filed: Mar. 11, 2023
(86) PCT No.: PCT/EP2023/056259

§ 371 Date: Sep. 10, 2025

(51) Int. Cl. C08L 23/22; B65D 53/06

(52) U.S. Cl. CPC C08L 23/22; B65D 53/06

(57) ABSTRACT

A container closure, in particular vacuum turn-lock closure, comprising a sealing element that contains or consists of a polymer compound (without PVC). The polymer compound comprises at least one polybutene-based polymer; at least one polymer that is derived from at least partially 1,2-linked isobutylene monomers; at least one (co)PP-based polymer, and optionally other components and additives.

The invention relates to a container closure, in particular a vacuum turn-lock closure, comprising a sealing element that contains or consists of a polymer compound. More specifically, the invention relates to container closures with a polymer-based sealing insert for bottles and other containers for holding beverages and foodstuffs. The container closures are free of halogenated substances and are also suitable for demanding applications.

Beverages and foodstuffs are filled into various types of containers for transport and storage. These containers often need to be sealable so that the contents do not leak and are also protected from the ingress of unwanted substances that would contaminate or damage the contents. In many applications, it is not only solid or liquid contaminants that are an issue. If the contents are sensitive to gaseous substances, these must also be prevented from entering. This is achieved by means of a suitably designed container closure.

Container closures made of metal and/or plastic have been known for a long time. In the form of screw caps, twist-off caps and crown caps, for example, they are used to seal containers such as bottles, jars and the like. Such containers have an opening that must be closed by the container closure. Vacuum (turn-lock) closures, which include Twist-Off® and press-on Twist-Off® closures, occupy a special position in this regard, as they must ensure vacuum retention for periods of up to three years instead of overpressure tightness.

The container must be sealed sufficiently tightly to prevent the contents from leaking out and to protect the contents from the ingress of undesirable substances, including gaseous substances such as oxygen, trichloroanisole and others, or loss of vacuum.

The necessary tightness is usually achieved by a sealing insert made of a material that is sufficiently strong on the one hand, but also elastic on the other, and is arranged in the container closure in such a way that it contacts the mouth of the container when the container closure is placed on the container. In most cases, the sealing insert is disc-shaped or ring-shaped and is arranged on the inside of the container closure. When the container is closed, it rests against the container opening and is pressed against the opening by the container closure, wherein its hardness together with its elasticity provides the seal. A good sealing insert compensates for the unevenness that is always present at the container opening. The more uneven the container opening is, the higher the demands placed on the sealing insert.

A key factor in meeting such requirements is the appropriate choice of material for the sealing insert. Many well-known materials are well suited for relatively simple applications, but less so or not at all for more demanding seals.

The sealing insert must also meet other requirements, such as being pasteurisable or even sterilisable for many applications. It must be able to withstand considerable internal pressure (e.g. in carbonated beverages), but yield in a controlled manner when this pressure is exceeded (overpressure valve effect). In the case of vacuum (turn-lock) closures, on the other hand, the sealing insert must also withstand external overpressure during certain pasteurisation and sterilisation processes and maintain the vacuum created in the container after cooling.

If the container closure is a turn-lock closure, the sealing insert must not offer too much resistance to the twisting of the container closure on the mouth when opening.

In addition, the sealing insert must be as easy as possible to manufacture and attach to the container closure. It is known to cut disc-shaped sealing inserts from webs or films and then attach them to the container closure (“out-shell moulding”) or, as is often preferred, to insert them into the container closure in a flowable form, where they are shaped and solidified (“in-shell moulding”). In-shell moulding also allows sealing inserts to be produced that are ring-shaped rather than disc-shaped.

In the case of polymer-based sealing inserts, this is conventionally done by introducing plastisol, followed by shaping and gelling (curing by heating), or, in the case of thermoplastic materials, by introducing the material in a heated, flowable state, followed by shaping and cooling.

While PVC-containing sealing inserts were widely used in the past, PVC and other halogen-containing materials are now the subject of considerable concern. They are considered potentially harmful to health and are also difficult to dispose of In many countries, the use of such halogen-containing materials is controlled or even prohibited by law or regulations.

There is thus a considerable need for container closures that do not contain halogenated materials, without having to forego the advantages that PVC-containing sealing inserts, for example, offer in terms of processing, sealing properties, costs and the like.

There are already a number of proposals for this in the prior art.

For example, it has been known for decades to manufacture sealing inserts for screw caps based on polymers that do not contain halogens.

Typical polymers in such compounds are thermoplastics, especially polyolefins, thermoplastic elastomers, elastic thermoplastics and synthetic rubbers. Typical additives are plasticisers, oils, lubricants, antioxidants, stabilisers, pigments, fillers and the like.

Many well-known sealing inserts are based on polyolefins, mostly derived from PP, PE and their copolymers.

Seal inserts based on poly(co)butenes, on the other hand, have been proposed much less frequently.

EP 3 302 918 already discloses polymer compounds based on special 1-butene copolymers, among other things, but these do not contain barrier polymers. These compounds are also said to be suitable for sealing inserts for container closures, but they are all very hard.

Against this background, it is an object of the invention to propose improved container closures, particularly with regard to the properties of the sealing element, the seal of which is based on butene polymers.

The combination of features in the independent claim serves to achieve this object.

Advantageous developments of the invention are defined in the dependent claims.

Container closures according to the invention, in particular vacuum turn-lock closures, are provided with a sealing element which contains or consists of a PVC-free polymer compound comprising at least one polybutene-based polymer;
at least one polymer derived from at least partially 1,2-linked isobutylene monomers;
at least one (co)PP-based polymer,
and optionally other components and additives.

In preferred embodiments of the invention, the polybutene-based polymer is a copolymer, in particular with ethylene, i.e. a PB/PE copolymer. Such copolymers are known in the prior art and are commercially available, e.g. from LyondellBasell.

In other embodiments, propylene may also be included, for example.

The polybutene-based polymer is preferably present in the sealing element in a proportion of 50-75% by weight, based on the total weight of the polymer components in the sealing element. It therefore usually forms the main component of the seal according to the invention.

In preferred embodiments of the invention, the polybutene-based polymer has a Shore A hardness of less than 85.

In preferred embodiments of the invention, the polymer derived from 1,2-linked isobutylene monomers is a copolymer, preferably a block copolymer.

Preferably, this copolymer comprises units based on isoprene and/or styrene.

The 1,2-linked polymer may also have 1,4-linkages in addition to the 1,2-linkages.

The 1,2-linked polymer may have barrier properties which in particular limit the passage of oxygen.

In this case, the 1,2-linked polymer preferably has an oxygen transmission rate (OTR) at 23° C. and 100% humidity of ≤5000, preferably a maximum of 2500, and particularly preferably a maximum of 1000 cm³/m²·d·bar, standardised to a layer thickness of 100 μm.

Preferably, the 1,2-linked polymer is an isobutylene/isoprene copolymer or an isobutylene/styrene copolymer, particularly preferably selected from
high-vinyl SEEPS with a vinyl content of more than 50% by weight, based on the total weight of SEEPS;
high-vinyl SEPS with a vinyl content of more than 50% by weight, based on the total weight of SEPS;
IIR (isobutylene-isoprene rubber; butyl rubber);
SIBS (styrene-isobutylene-styrene block copolymer);
PIB (polyisobutylene);
and mixtures thereof,
   wherein the copolymer preferably has a Shore A hardness between 20 and 65 and is preferably present in a content of 10 to 30% by weight, based on the total weight of the polymers in the sealing material.

Preferably, the 1,2-linked polymer is rubber-like.

By “high-vinyl”, we mean, in accordance with US 1,0457,805 B2, such styrene block copolymers of which the vinyl content prior to hydrogenation is greater than 50 mol %. After hydrogenation, the copolymer naturally contains hardly any or even no aliphatic double bonds.

Nevertheless, we also refer to such styrene block copolymers as “high-vinyl” because they can be derived from precursors with such high vinyl contents.

By “rubber-like” we mean polymers that resemble known synthetic rubbers in their mechanical properties that are essential for sealing functions (such as hardness or softness and elasticity). Suitable reference substances are butyl rubber (IIR) or styrene block copolymers such as SBS or SEBS, e.g. commercially available products.

The styrene block copolymer preferably has a styrene content of less than 25% by weight, based on the total weight of styrene block copolymer.

Particularly suitable are hydrogenated styrene block copolymers with butadiene middle blocks (1,2- and/or 1,4-linked), e.g. high-vinyl SEBS and high-vinyl SE(E)PS.

These polymers differ from one another in terms of the molecular middle blocks, which are composed of the hydrogenated sequences of butadiene (1,2 and/or 1,4-linked) and/or isoprene.

Such copolymers can be obtained, for example, from Kraton Corp., TSRC Corp., Kuraray or Dynasol. Typical suitable products are Kraton G1645, Kraton G1643, Vector 8245 or Calprene H6180, and if oxygen barriers need to be improved, raw materials such as the Hybrar 7000 series, in which isoprene is copolymerised in addition to butadiene.

In preferred embodiments of the container closure according to the invention, the high-vinyl styrene block copolymer is present in a proportion of 10-40% by weight, based on the total weight of the polymer components in the sealing element.

The styrene block copolymer is preferably relatively soft and has a Shore A hardness of less than 65.

In preferred embodiments of the invention, the styrene block copolymer has an MFI (190° C., 5 kg) of ≥0 g/10 min, wherein the materials according to the invention may not melt or are only partially thermoplastic.

In these and other preferred embodiments of the invention, the (co)PP-based polymer contains or consists of a PP homopolymer or a PP copolymer with a Shore D hardness of more than 65, wherein the content of this polymer in the sealing material is preferably between 10 and 20% by weight, based on the total weight of the polymers in the sealing material.

Alternatively, the (co)PP-based polymer comprises a PP copolymer with a Shore D hardness of less than 40 or consists of such a PP copolymer, wherein the content of this polymer in the sealing material is preferably between 10 and 40% by weight, based on the total weight of the polymers in the sealing material.

In preferred embodiments, the PP copolymer comprises at least one terpolymer, a butene-propene and/or ethene-containing copolymer, optionally with proportions of hexene or octene, or consists thereof

The sealing material preferably has a total Shore A hardness of ≤80, measured after 10 days at 23° C., and an oxygen transmission rate (OTR) measured at 23° C. and 100% humidity of ≤5000 cm³/m²·d·bar, standardised to a layer thickness of 100 μm.

The sealing material according to the invention, or the sealing element made from it, is therefore preferably relatively soft and thus suitable for the intended use.

In addition to the above-mentioned components, the compound may comprise further components which serve to adjust its sealing properties, improve its processing or serve other purposes.

Preferred embodiments of the sealing material comprise at least a mineral filler, in particular talc, especially in a content of up to 20% by weight, based on the total weight of the sealing element.

Further embodiments of the invention use at least one plasticiser, in particular white oil or a synthetic oil based on polyolefin, preferably in a content of up to 10% by weight, based on the total weight of the sealing element. In any case, this is usually unproblematic if the filling material in the container is not greasy or oily. Otherwise, care must be taken to ensure that oil contents in the seal do not lead to migration problems, which may result in the partial or complete elimination of such components of the compound (e.g. oil) that contribute to such migration problems.

The following practical example A1 to A11 illustrate the invention:

The PB-1-Et copolymer used in the examples, except for example A7, had an Et content of ~15% as determined by ¹H-NMR.

The Pb-1-Et copolymer used in Example A7 had an Et content of ~6% as determined by ¹H-NMR.

These copolymers were obtained from LyondellBasell under the names Purell KT MR 07 and Koattro DP 8310 M.

The SIBS used was Sibstar 102T-FD from Kaneka.

The IIR used was X_Butyl RB 101-3 from Arlanxeo.

The SEEPS used was Hybrar 7311 from Kiuraray.

The random coPP used was RD 204 CF from Borealis.

The homo-PP used was HD 204CF from Borealis.

The heterophasic coPP used was Dupure SL50 from Ducor Petrochemicals.

The modulus of elasticity for the materials in question was measured in accordance with DIN 53504 after 48 hours of storage on S2 test specimens punched out of pressed plates. To determine the modulus of elasticity, a test speed of 200 mm/min and a range between 0.05 and 0.25% elongation were used.

### EXAMPLES

| | Examples | | | | | | | | | | |
|---|---|---|---|---|---|---|---|---|---|---|---|
| | A1 | A2 | A3 | A4 | A5 | A6 | A7 | A8 | A9 | A10 | A11 |
| PB-1-Et | 52.00% | 72.00% | 52.00% | 72.00% | 32.00% | 42.00% | | 62.00% | 72.00% | 72.00% | 72.00% |
| copolymer | | | | | | | | | | | |
| PB-1-Et (low Et) | | | | | | | 72.00% | | | | |
| copolymer | | | | | | | | | | | |
| SIBS | 30.00% | | | | 10.00% | 30.00% | 10.00% | 10.00% | 10.00% | 10.00% | 10.00% |
| IIR | | 10.00% | 30.00% | | | | | | | | |
| Vinyl-rich | | | | 10.00% | | | | | | | |
| SEEPS | | | | | | | | | | | |
| random coPP | 14.85% | 14.85% | 14.85% | 14.85% | 54.85% | 24.85% | 14.85% | 14.85% | 14.85% | | |
| homoPP | | | | | | | | | | 14.85% | |
| heterophasic | | | | | | | | | | | 14.85% |
| coPP | | | | | | | | | | | |
| White oil | | | | | | | | 10.00% | | | |
| Lubricant | 2.50% | 2.50% | 2.50% | 2.50% | 2.50% | 2.50% | 2.50% | 2.50% | 2.50% | 2.50% | 2.50% |
| Stabilisers | 0.35% | 0.35% | 0.35% | 0.35% | 0.35% | 0.35% | 0.35% | 0.35% | 0.35% | 0.35% | 0.35% |
| Titanium dioxide | 0.30% | 0.30% | 0.30% | 0.30% | 0.30% | 0.30% | 0.30% | 0.30% | 0.30% | 0.30% | 0.30% |
| | 100% | 100% | 100% | 100% | 100% | 100% | 100% | 100% | 100% | 100% | 100% |
| Shore A, 5 s, | 56 | 53 | 55 | 51 | 93 | 74 | 87/ | 49 | 54 | 57 | 50 |
| 30 min storage | | | | | | | D32 | | | | |
| Shore A, 5 s, | 72 | 72 | 69 | 71 | D40 | 82 | D42 | 62 | 74 | 75 | 74 |
| 10 d storage | | | | | | | | | | | |
| MFR [g/10 min], | 3 | 5 | 4 | 5 | 7 | 4 | 11 | 10 | 5 | 5 | 5 |
| 190° C., 5 kg | | | | | | | | | | | |
| OTR [cm³ · 100 | 2926 | 4025 | 2800 | 4582 | 1875 | 2370 | 1575 | 5100 | 3805 | 4173 | 4446 |
| μm/m² · d · bar], | | | | | | | | | | | |
| 100% relative | | | | | | | | | | | |
| humidity | | | | | | | | | | | |
| Modulus of | 22.3 | 19.7 | 18.1 | 14.2 | 220.0 | 33.9 | 194.0 | 15.9 | 16.3 | 17.0 | 17.6 |
| elasticity after 48 | | | | | | | | | | | |
| hours of storage | | | | | | | | | | | |
| test specimen S2 | | | | | | | | | | | |
| longitudinally | | | | | | | | | | | |
| Based on DIN | | | | | | | | | | | |
| 53504 | | | | | | | | | | | |

1. A vacuum turn-lock closure comprising a sealing element that includes a polymer compound without PVC, wherein the polymer compound comprises:
at least one polybutene-based copolymer;
at least one polymer that is derived from at least partially 1,2-linked isobutylene monomers; and
at least one (co)PP-based polymer

2. The container closure according to claim 1, wherein the polybutene-based copolymer comprises a copolymer with ethylene.

3. The container closure according to claim 1, wherein the polybutene-based copolymer is present in a proportion of 50-75% by weight, based on the total weight of the polymer components in the sealing element.

4. The container closure according to claim 1, in which the polybutene-based polymer has a Shore A hardness of less than 85.

5. The container closure according to claim 1, wherein the polymer compound comprises at least one isobutylene-based copolymer which contains isoprene and/or styrene as comonomer.

6. The container closure according to claim 1, wherein the 1,2-linked polymer also has 1,4-linkages in addition to the 1,2-linkages.

7. The container closure according to claim 1, wherein the 1,2-linked polymer has a Shore A hardness of at most 80.

8. The container closure according to claim 1, wherein the 1,2-linked polymer has an oxygen transmission rate (OTR) measured at 23° C. and 100% humidity of ≤5000 cm3/m2·d·bar, standardized to a layer thickness of 100 μm.

9. The container closure according to claim 5, wherein the copolymer comprises one or more of:
high-vinyl SEEPS with a vinyl content of more than 50% by weight, based on the total weight of SEEPS;
high-vinyl SEPS with a vinyl content of more than 50% by weight, based on the total weight of SEPS;
IIR (isobutylene-isoprene rubber; butyl rubber);
SIBS (styrene-isobutylene-styrene block copolymer);
PIB (polyisobutylene);
and mixtures thereof,
wherein the copolymer has a Shore A hardness between 20 and 60
and is present in a content of 10 to 30% by weight, based on the total weight of the polymers in the sealing material.

10. The container closure according to claim 1, in which the (co)PP-based polymer includes a PP homopolymer or a PP copolymer with a Shore D hardness greater than 65, wherein the content of this polymer in the sealing material is preferably between 10 and 20% by weight, based on the total weight of the polymers in the sealing material.

11. The container closure according to claim 1, wherein the (co)PP-based polymer contains or consists of a PP copolymer with a Shore D hardness of less than 40, wherein the content of this polymer in the sealing material is preferably between 10 and 40% by weight, based on the total weight of the polymers in the sealing material.

12. The container closure according to claim 11, wherein the PP copolymer includes at least one terpolymer.

13. The container closure according to claim 1, wherein the sealing material has a total Shore A hardness 80, measured after 10 days at 23° C., and an oxygen transmission rate (OTR) measured at 23° C. and 100% humidity of 5000 cm3/m2·d·bar, standardized to a layer thickness of 100 μm.

14. The container closure according to claim 1, further comprising talc in a content of up to 20% by weight, based on the total weight of the sealing element.

15. The container closure according to claim 1, further comprising at least one plasticizer in a content of up to 10% by weight, based on the total weight of the sealing element.

16. The container closure according to claim 1, wherein the polymer compound has an oxygen transmission rate (OTR) measured at 23° C. and 100% humidity of ≤5000 cm³/m2·d·bar standardized to a layer thickness of 100 μm.

17. The container closure according to claim 1, wherein the polymer compound consists of:
at least one polybutene-based copolymer;
at least one polymer that is derived from at least partially 1,2-linked isobutylene monomers; and
at least one (co)PP-based polymer;
and optionally a filler and optionally a plasticizer.

18. The container closure of claim 5, wherein at least one isobutylene-based copolymer which contains isoprene and/or styrene as comonomer is a block copolymer.

19. The container closure of claim 12, wherein the terpolymer (1) container propene, ethene and/or butene; or (2) includes at least one copolymer containing propene and/or ethene.
